(19) United States
(12) Patent Application Publication
(10) Pub. No.: US 2006/0253848 A1
(43) Pub. Date: Nov. 9, 2006

(54) Method and apparatus for solutions deployment in a heterogeneous systems management environment

(75) Inventors: Arnaud Airy Mathieu, Austin, TX (US); Puthukode G. Ramachandran, Austin, TX (US)

Correspondence Address: IBM CORP (YA);C/O YEE & ASSOCIATES PC, P.O. BOX 802333, DALLAS, TX, 75380, US

(73) Assignee: International Business Machines Corporation, Armonk, NY (US)

(21) Appl. No.: 11/122,903

(22) Filed: May 5, 2005

(51) Int. Cl. G06F 9/44

(52) U.S. Cl. 717/168

(57) ABSTRACT

A method, apparatus, and computer usable code for deploying software in a data center and desktop computers. A set of software distribution applications within the data center or IT infrastructure are identified. In response to receiving a request to install software, installation parameters associated with the software to be installed are compared to characteristics for the set of software distribution applications. A software distribution application is selected from the set of software distribution applications based on comparing the installation parameters associated with the software to the characteristics for the set of software distribution applications. The selected software distribution application is used to install the software.

### BACKGROUND OF THE INVENTION

1. Technical Field

The present invention relates to an improved data processing system and in particular, the present invention relates to a method and apparatus for deploying applications. Still more particularly, the present invention relates to a method, apparatus, and computer usable code for deploying software in a data center and desktop environment.

2. Description of Related Art

A data center is a centralized storage and management facility that is used to provide information and manage components. These components may include, for example, servers, switches, routers, and databases. In a data center, resources and deployment of software, for an available service may be represented using a deployment plan. This software may be, for example, a distributed application that is to be deployed to servers being managed by the data center. Datacenter is a location where applications, such as mission critical applications run. For example company Web servers and e-commerce servers are usually located in datacenters that provide fault redundant availability. Currently, many data centers are heterogeneous in which a number of different management products may be present in the data center in which different system management products may offer better features or functionality for particular uses. For example, a customer may use Tivoli Configuration Manager for software distribution and Tivoli Provisioning Manager to manage operating system images. These two different systems provide separate user interfaces and separate databases used for managing the different data processing systems within the data center. Tivoli Configuration Manager and Tivoli Provisioning Manager are products of International Business Machines Corporation. Additionally, another system, such as the server management suite from Altiris may be used for software distribution and for operating system provisioning. As a result, a data center administrator has to learn a number of different technologies and how to use several different user interfaces to perform solution deployment on servers for the data center. This type of process is complicated and error prone.

Some software distribution applications distribute proprietary software packaging formats while other software distribution applications distribute native operating system formats. For example, these formats include Microsoft Installer (MSI) for Windows and Installshield Multiplatform (ISMP). Some software distribution applications may distribute software over a wide area network (WAN) while other software distribution applications only work within a local area network (LAN).

One solution is to use only a single product within a data center and desktops. This type of solution, however, does not offer for the best features for all functions to a customer. Thus, it would be advantageous to have an improved method, apparatus, and computer usable code to deploy software in a data center and desktops having a heterogeneous environment containing several different software distribution applications.

### SUMMARY OF THE INVENTION

The present invention provides a method, apparatus, and computer usable code for deploying software in a network data processing system. A set of software distribution applications within the network data processing system are identified. In response to receiving a request to install software, installation parameters associated with the software to be installed are compared to characteristics for the set of software distribution applications. A software distribution application is selected from the set of software distribution applications based on comparing the installation parameters associated with the software to the characteristics for the set of software distribution applications. The selected software distribution application is used to install the software.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a network of data processing systems in which an illustrative embodiment of the present invention may be implemented;

FIG. 2 is a block diagram of a data processing system that may be implemented as a server depicted in accordance with an illustrative embodiment of the present invention;

FIG. 3 is a block diagram illustrating a data processing system depicted in which an illustrative embodiment of the present invention may be implemented;

FIG. 4 is a diagram illustrating a data center depicted in accordance with an illustrative embodiment of the present invention;

FIG. 5 is a diagram illustrating components used in deploying software depicted in accordance with an illustrative embodiment of the present invention;

FIGS. 6A-6B are user interfaces for identifying software distribution applications depicted in accordance with an illustrative embodiment of the present invention;

FIGS. 7A-7G are diagrams illustrating deployment of software depicted in accordance with an illustrative embodiment of the present invention;

FIG. 8 is a flowchart of a process for discovering software distribution applications depicted in accordance with an illustrative embodiment of the present invention; and

FIG. 9 is a flowchart of a process for deploying software using software distribution applications depicted in accordance with an illustrative embodiment of the present invention.

### DETAILED DESCRIPTION OF THE PREFERRED EMBODIMENT

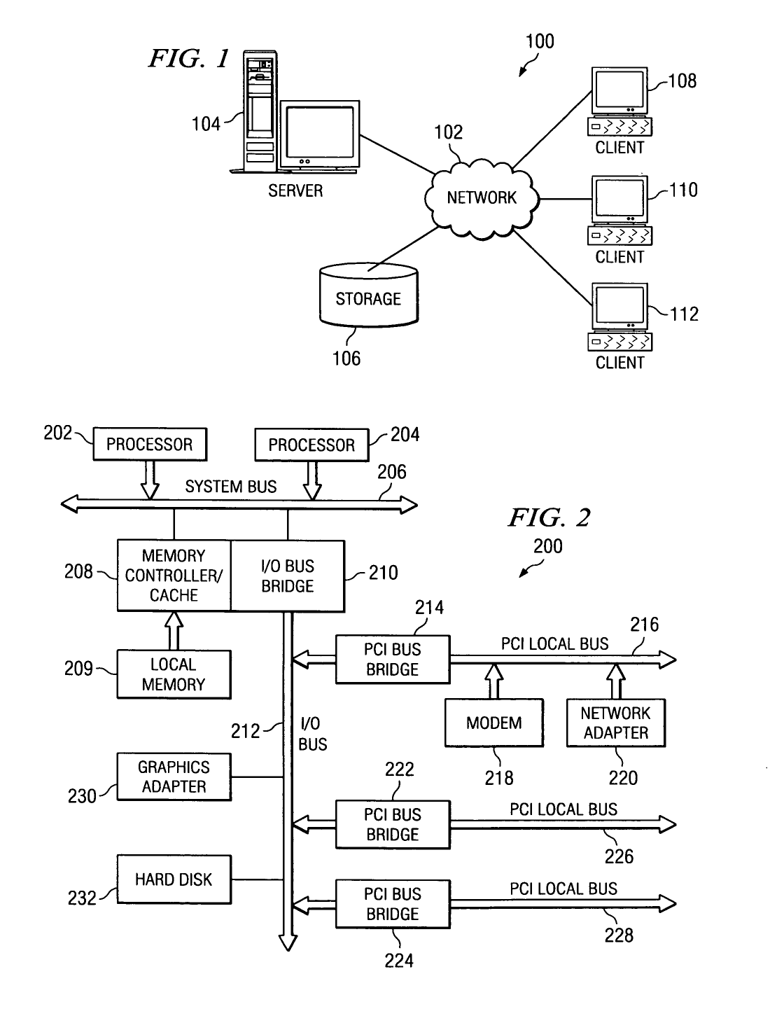

With reference now to the figures, FIG. 1 depicts a pictorial representation of a network of data processing systems in which an illustrative embodiment of the present invention may be implemented. Network data processing system 100 is a network of computers in which the present invention may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 is connected to network 102 along with storage unit 106. In addition, clients 108, 110, and 112 are connected to network 102. Clients 108, 110, and 112 may be, for example, personal computers or network computers. In the depicted example, server 104 provides data, such as boot files, operating system images, and applications to clients 108, 110 and 112. Clients 108, 110, and 112 are clients to server 104. Network data processing system 100 may include additional servers, clients, and other devices not shown. In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational, and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

Referring to FIG. 2, a block diagram of a data processing system that may be implemented as a server, such as server 104 in FIG. 1, is depicted in accordance with an illustrative embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O Bus Bridge 210 is connected to system bus 206 and provides an interface to I/O bus 212. Memory controller/cache 208 and I/O Bus Bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to clients 108, 110 and 112 in FIG. 1 may be provided through modem 218 and network adapter 220 connected to PCI local bus 216 through add-in connectors.

Additional PCI bus bridges 222 and 224 provide interfaces for additional PCI local buses 226 and 228, from which additional modems or network adapters may be supported. In this manner, data processing system 200 allows connections to multiple network computers. Memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM® eServer pSeries® system, a product of International Business Machines Corporation in Armonk, N.Y., running the Advanced Interactive Executive (AIX) operating system or the LINUX operating system.

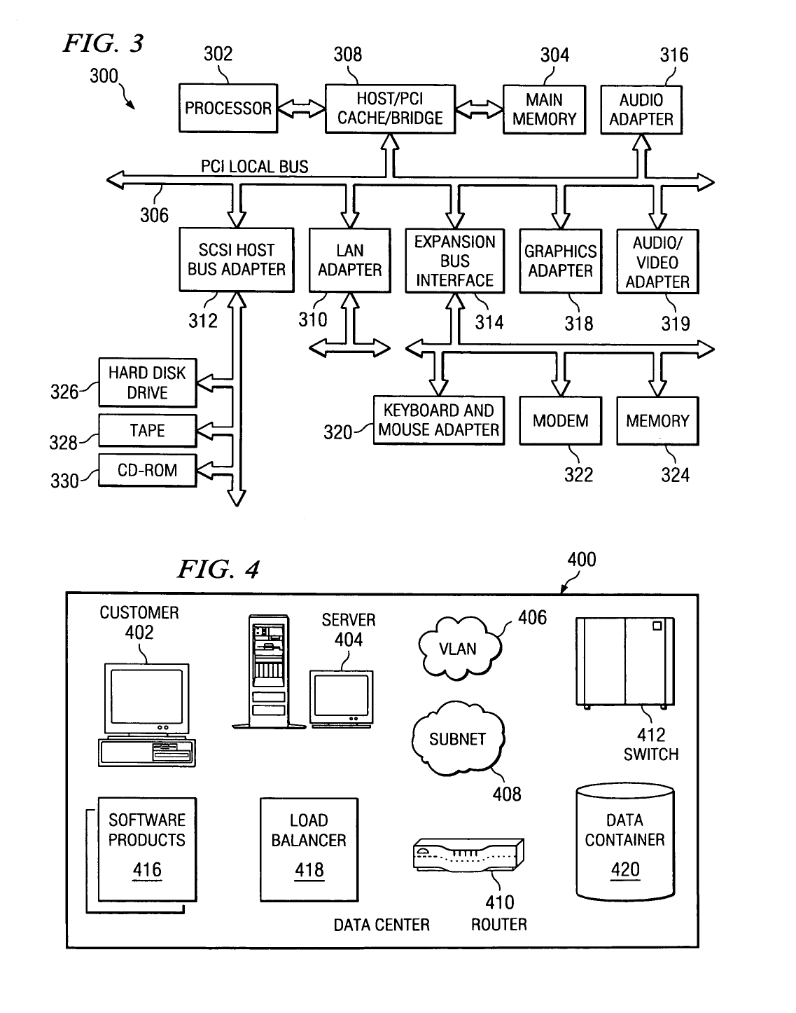

With reference now to FIG. 3, a block diagram illustrating a data processing system is depicted in which an illustrative embodiment of the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI Bridge 308. PCI Bridge 308 also may include an integrated memory controller and cache memory for processor 302. Additional connections to PCI local bus 306 may be made through direct component interconnection or through add-in boards. In the depicted example, local area network (LAN) adapter 310, small computer system interface (SCSI) host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for keyboard and mouse adapter 320, modem 322, and memory 324. SCSI host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows XP, which is available from Microsoft Corporation. An object-oriented programming system, such as Java, may run in conjunction with the operating system and provide calls to the operating system from Java programs or applications executing on data processing system 300. “Java” is a trademark of Sun Microsystems, Inc. Instructions for the operating system, the object-oriented programming system, and applications or programs are located on storage devices, such as hard disk drive 326 and may be loaded into main memory 304 for execution by processor 302.

Those of ordinary skill in the art will appreciate that the hardware in FIG. 3 may vary depending on the implementation. Other internal hardware or peripheral devices, such as flash read-only memory (ROM), equivalent non-volatile memory, or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interfaces. As a further example, data processing system 300 may be a personal digital assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 also may be a notebook computer or hand-held computer in addition to taking the form of a PDA. Data processing system 300 also may be a kiosk or a Web appliance.

A bus system may be comprised of one or more buses, such as system bus 206, I/O bus 212 and PCI buses 216, 226 and 228 as shown in FIG. 2. Of course the bus system may be implemented using any type of communications fabric or architecture that provides for a transfer of data between different components or devices attached to the fabric or architecture. A communications unit may include one or more devices used to transmit and receive data, such as modem 218 or network adapter 220 of FIG. 2 or modem 322 or LAN 312 of FIG. 3. A memory may be, for example, local memory 209 or cache such as found in memory controller/cache 208 of FIG. 2 or main memory 304 of FIG. 3. A processing unit may include one or more processors or CPUs, such as processor 202 or processor 204 of FIG. 2 or processor 302 of FIG. 3. The depicted examples in FIGS. 1-3 and above-described examples are not meant to imply architectural limitations. For example, data processing system 300 also may be a tablet computer, laptop computer, or telephone device in addition to taking the form of a PDA.

The present invention provides a method, apparatus, and computer usable code for distributing software in a network data processing system. The mechanism of the present invention may be applied to a network data processing system such as a data center and to clients or desktop environments serviced by the data center. More specifically, the software may take the form of a software application or program. Of course, other types of computer usable code may be deployed using the mechanisms of the present invention. As another example, a patch, which is a fix for a program, may be distributed to various data processing systems within data center 400. Additionally, this deployment scheme also may be used to deploy software to data processing systems and other devices associated with, controlled by, or connected to data center 400. In one illustrative example, the mechanism of the present invention identifies a set of software distribution applications that are present within the data center. The characteristics of these software distribution applications are identified and saved within a database in the data center. When a request is made to install software, the request may include characteristics that are desired for a software distribution application that is to be used to distribute or deploy the software. These characteristics are referred to as installation parameters.

The installation parameters are compared to the characteristics for the set of software distribution applications. If a match occurs with a particular software distribution application, that software distribution application is selected to deploy the software. If a match is not present, the user may be prompted to change installation parameters or select another software distribution application that most closely fits the installation parameters. Additionally, the selection of another software distribution application that is the closest match to the installation parameters may be made automatically depending on the particular implementation.

Turning now to FIG. 4, a diagram illustrating a data center is depicted in accordance with an illustrative embodiment of the present invention. In this example, data center 400 may implement the different features, components, and processes of the present invention. As shown in FIG. 4, in this illustrative example, data center 400 includes resources, such as, customer 402, server 404, Virtual Local Area Network (VLAN) 406, subnet 408, router 410, switch 412, software products 416, load balancer 418, and data container 420.

Customer 402 may be, for example, a client or an administrator who uses a data processing system, such as data processing system 300 in FIG. 3. Server 404 may be implemented as a data processing system, such as data processing system 200 in FIG. 2. Server 404 may also be implemented as an application server, which hosts Web services or other types of servers. Router 410 and switch 412 facilitate communications between different devices. VLAN 406 is a network of computers that behave as if they are connected to the same wire even though they may actually be physically located on different segments of a local area network. Subnet 408 is a portion of a network, which may be a physically independent network segment and shares a network address with other portions of the network.

Software products 416 are applications that may be deployed to a client or a server. Load balancer 418 spreads traffic among multiple systems such that no single system is overwhelmed. Load balancer 418 is normally implemented as software running on a data processing system. Data container 420 may be a database, such as DB2 Universal Database, a product available from International Business Machines Corporation.

Data center 400, as depicted in FIG. 4, is presented for purposes of illustrating the present invention. Other resources, such as, for example, a cluster of servers and switch ports, also may be included in data center 400. The mechanism of the present invention deploys and exploits multiple instances of applications, such as software products 416, using an application deployment template in automated data centers, such as data center 400. The processes of the present invention may be performed by a processing unit, comprising one or more processors, such as processor 302 in FIG. 3, using computer implemented instructions, which may be located in a memory such as, for example, main memory 304, memory 324, or in one or more peripheral devices 326 and 330.

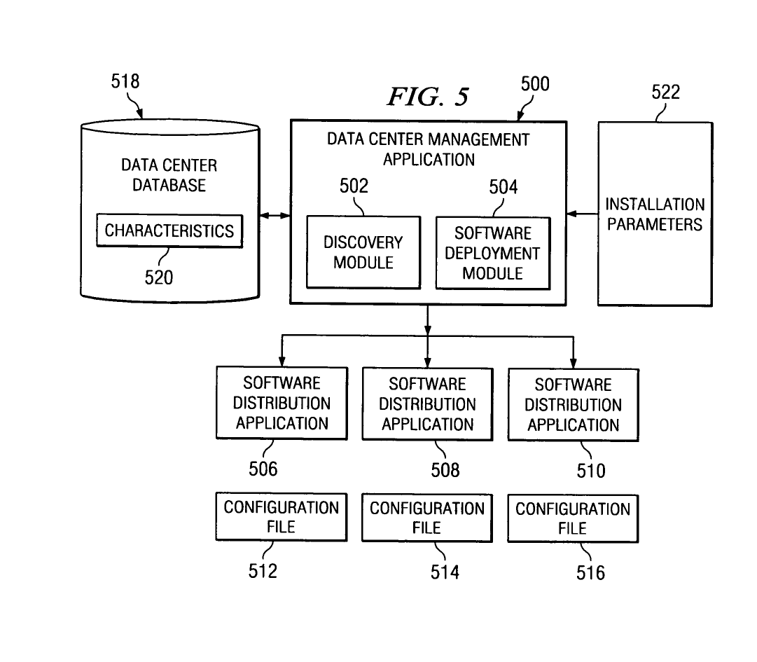

With reference now to FIG. 5, a diagram illustrating components used in deploying software is depicted in accordance with an illustrative embodiment of the present invention. In this example, data center management application 500 contains discovery module 502 and software deployment module 504. Data center management application 500 is an example of computer usable code that may be found within data center 400 in FIG. 4. For example, data center management application 500 may reside on server 404. Depending on the particular implementation, this application may be distributed across multiple servers. Data center management application 500 may be implemented by modifying existing data center management applications that are presently available to include the features, components, and processes of the present invention.

In this illustrative example, discovery module 502 is an additional component that is included to search for and identify software deployment applications within the data center. Discovery module 502 identifies software distribution applications 506, 508, and 510. Additionally, discovery module 502 obtains information about these applications. The software distribution applications can be discovered by scanning the network. Some software distribution applications like Tivoli Configuration Manager can be identified by certain daemons running on predefined ports of the server. Once the software distribution application is identified the user will have to provide the Administrator credentials of the application and the discovery module can use the APIs of the software distribution application to get it's configuration properties

These characteristics may be obtained in a number of different ways, depending on the particular implementation. For example, user input from an administrator may be used to obtain characteristics about software distribution applications 506, 508, and 510. In this illustrative example, the information is identified from configuration files 512, 514, and 516. These configuration files are associated with software distribution applications 506, 508 and 510. These applications may be implemented using currently available software distribution applications. For example, a software distribution application may take the form of Tivoli Configuration Manager, IBM Director, and OPSWARE Server Automation System. Tivoli Configuration Manager and IBM Director are products available from International Business Machines Corporation. OPSWARE Server Automation System is a product available from Opsware, Inc.

Discovery module 502 identifies the presence of these configuration files and stores characteristics of each of these software distribution applications in data center database 518 in this illustrative example. In this manner, discovery module 502 identifies characteristics for the set of software distribution applications located within the data center.

These characteristics include, for example, without limitation, bandwidth constraints, whether asynchronous deployment is supported, and the types of devices to which distribution may be made. Other examples include whether the software distribution application supports disconnected PDAs or desktop computers, whether the software package is compressed during distribution, whether multicasting to several target servers is possible, etc. Bandwidth constraints identifies the amount of network resources that can be used by the software distribution application to distribute the software. Asynchronous deployment indicates whether the software distribution application is able to asynchronously deploy the software. Distribution to devices identifies which devices to which the software distribution application may deploy the software. For example, some software distribution applications may only deploy software to servers, while others may deploy software to servers and work stations. Further, in other cases, the deployment may also be made to other devices, such as personal digital assistance, desktop computers, routers, and switches. Characteristics 520 are located within data center database 518.

When a request is received to deploy software, this request typically includes installation parameters 522. These installation parameters contain the information needed to deploy the software. These parameters include quantifiable properties as well as non-quantifiable properties. Quantifiable properties include constraints imposed based on factors, such as business objectives and service level agreements and the value can be easily estimated. Quantifiable properties include, for example, the bandwidth, whether a synchronous distribution is desired, and a time to deploy the software. For example, an installation may require that only ten percent of the bandwidth is used to deploy software to a location in Toronto Canada. These properties also may include a requirement that a software distribution application a synchronously distribute the software at night. Other examples include whether software distribution application supports disconnected PDAS, whether the software package is compressed during distribution, whether multicasting to several target servers is possible etc. Non-quantifiable properties are properties that cannot be easily estimated. Non-quantifiable properties include, for example, things that users, such as system administrators learn by experience. For example a software distribution application on a Windows operating system crashes compared to the same software distribution application on Linux. Another example is if the distribution succeeds more often while distributing an Enterprise Archive file if Tivoli Configuration Manager is used instead of OPSWARE.

In this example, installation parameters 522 are received by software deployment module 504. Software deployment module 504 is modified from currently available modules to include processes to compare installation parameters 522 with characteristics 520 for the set of software distribution applications. If a match occurs between installation parameters 522 and characteristics 520 for a particular software distribution application, that software distribution application is selected to distribute the software. If a match does not occur, a determination is made as to whether non-quantifiable attributes nearly match. Near matches can be accepted using a policy that determines whether a certain percentage of the attributes match. The percentage selected depends on the particular implementation. Software deployment module 504 may select the software distribution application that has characteristics that most closely match the installation parameters. Alternatively, the user may be presented with the different software distribution applications and their characteristics. The user may then select a particular software distribution application to distribute the software or alter installation parameters.

Software deployment module 504 sends commands and data to the selected software distribution application to initiate deployment of the software. In these examples, the commands and data are translated or formatted into a form usable by the selected software distribution application. These processes may be located at software deployment module 504 or within the selected software deployment module. Additionally, these processes also may be located as agents or modules associated with the software distribution applications depending on the particular implementation.

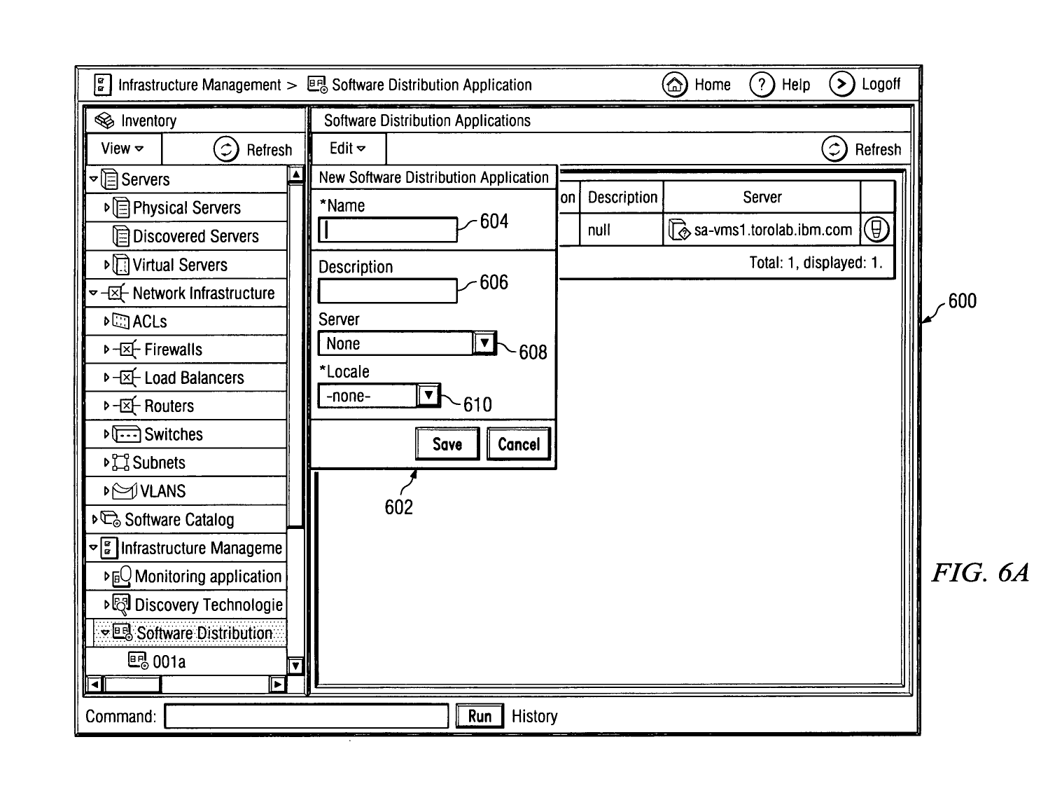

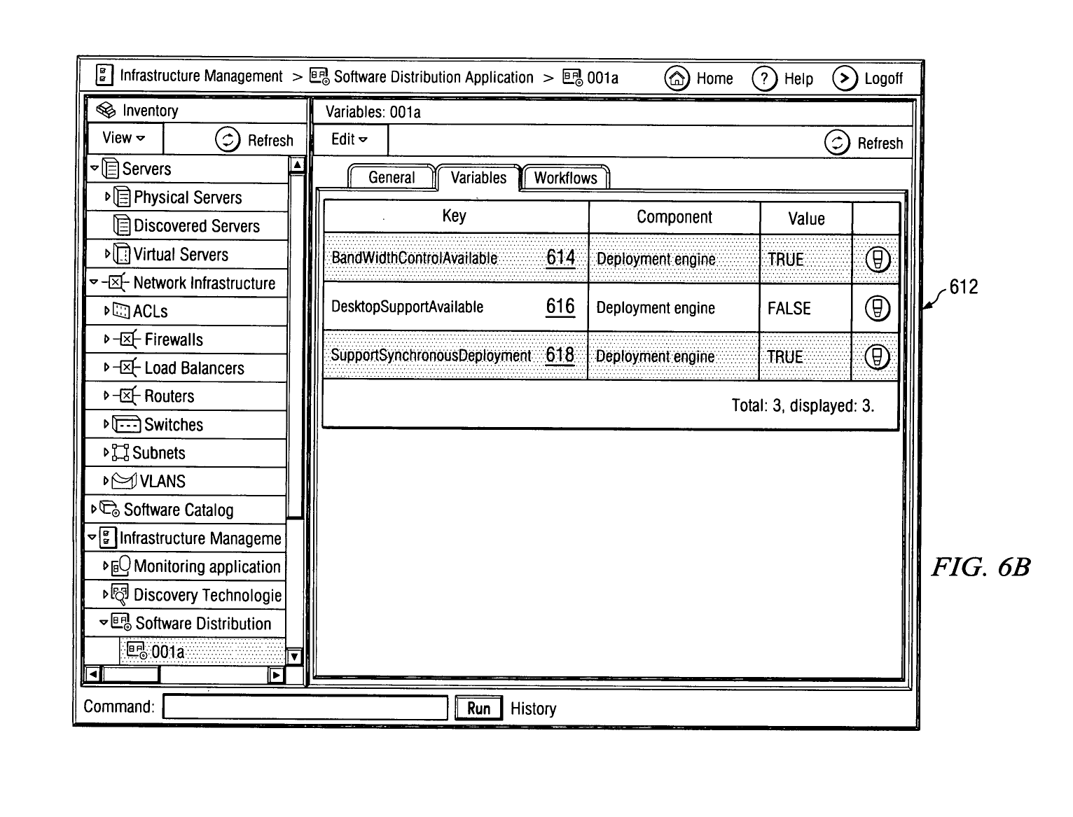

Turning now to FIGS. 6A-6B, user interfaces for identifying software distribution applications are depicted in accordance with an illustrative embodiment of the present invention. In FIG. 6A, user interface 600 depicts fields for entering information about a software distribution application in section 602. As can be seen, field 604 allows a name for the software distribution application to be entered. A description of the software distribution application may be entered in field 606. The name of a server on which this application may be located is identified in field 608. Field 610 allows for a location to be entered for the software distribution application. In FIG. 6B, user interface 612 illustrates examples of characteristics that may be associated with a software distribution application. Entry 614 and user interface 612 illustrates that bandwidth control is available. Entry 616 illustrates that desktop support is unavailable for this software distribution application. A synchronous deployment is supported as shown in entry 618.

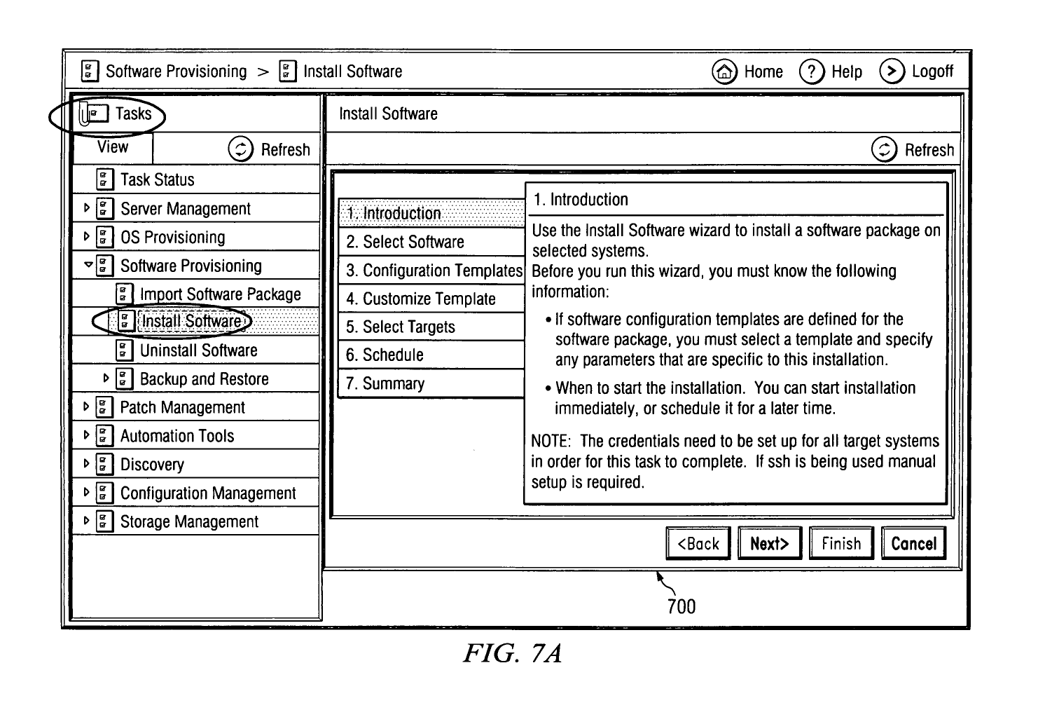

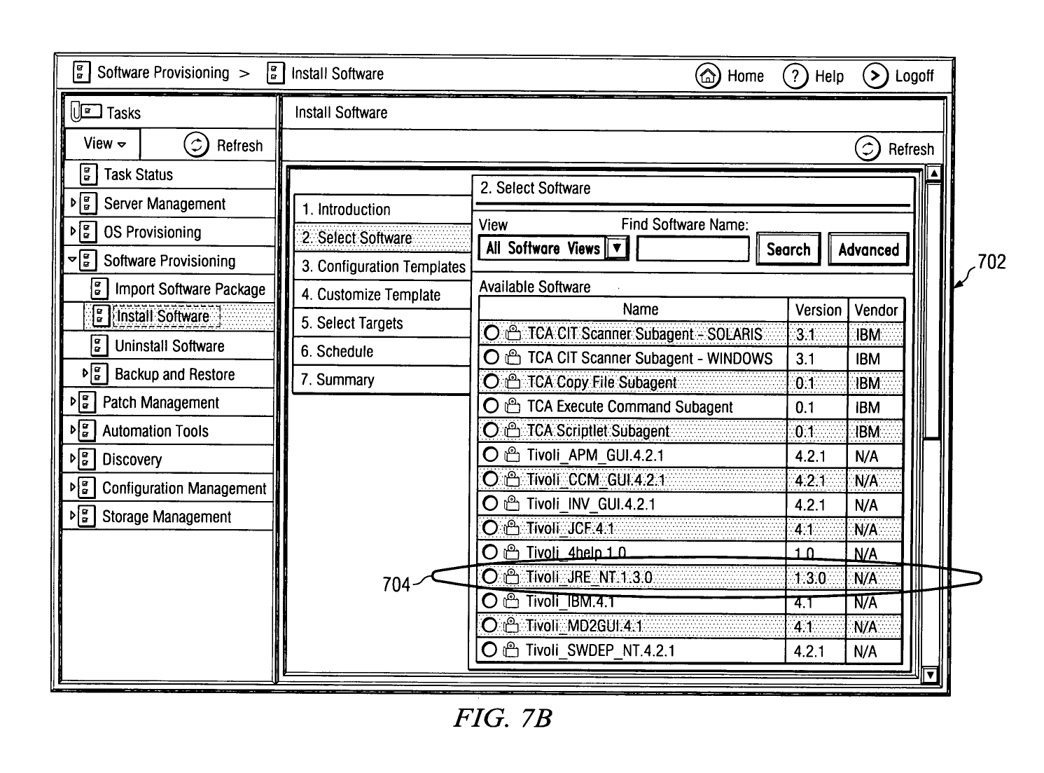

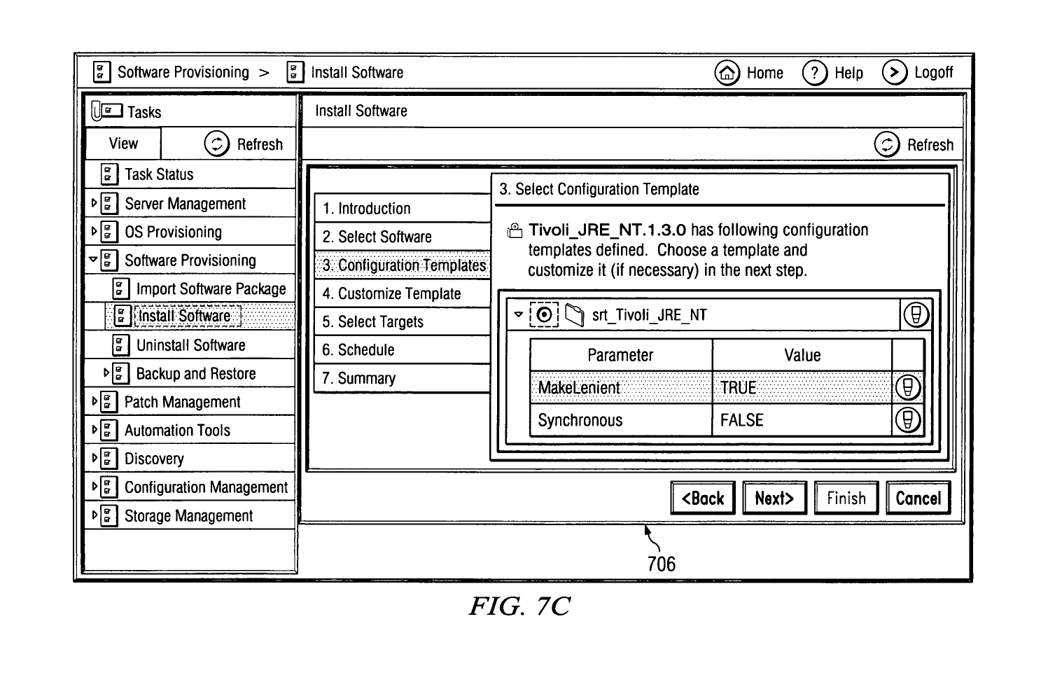

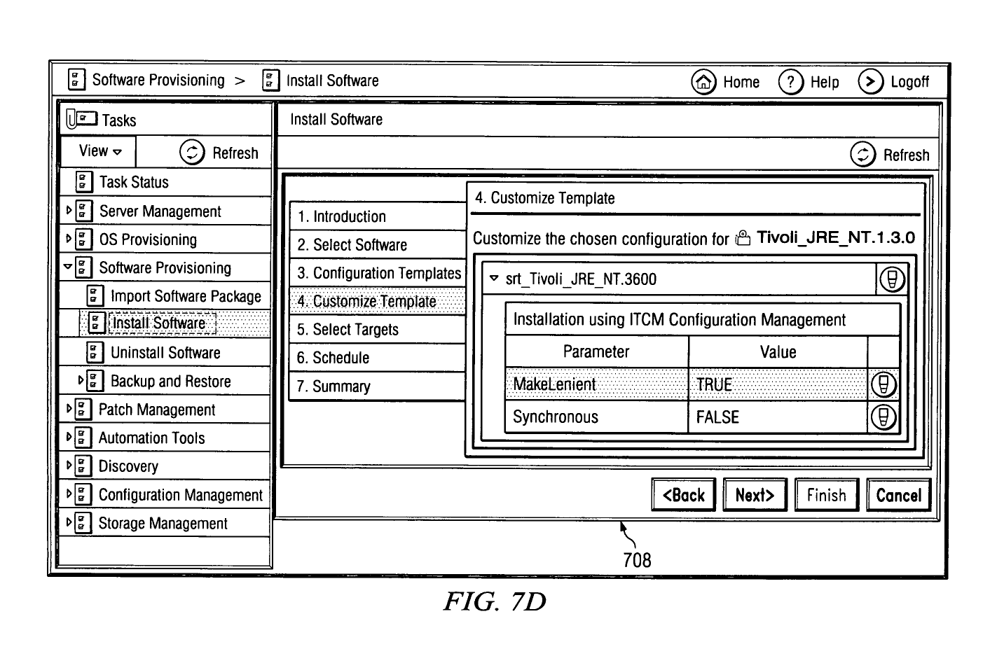

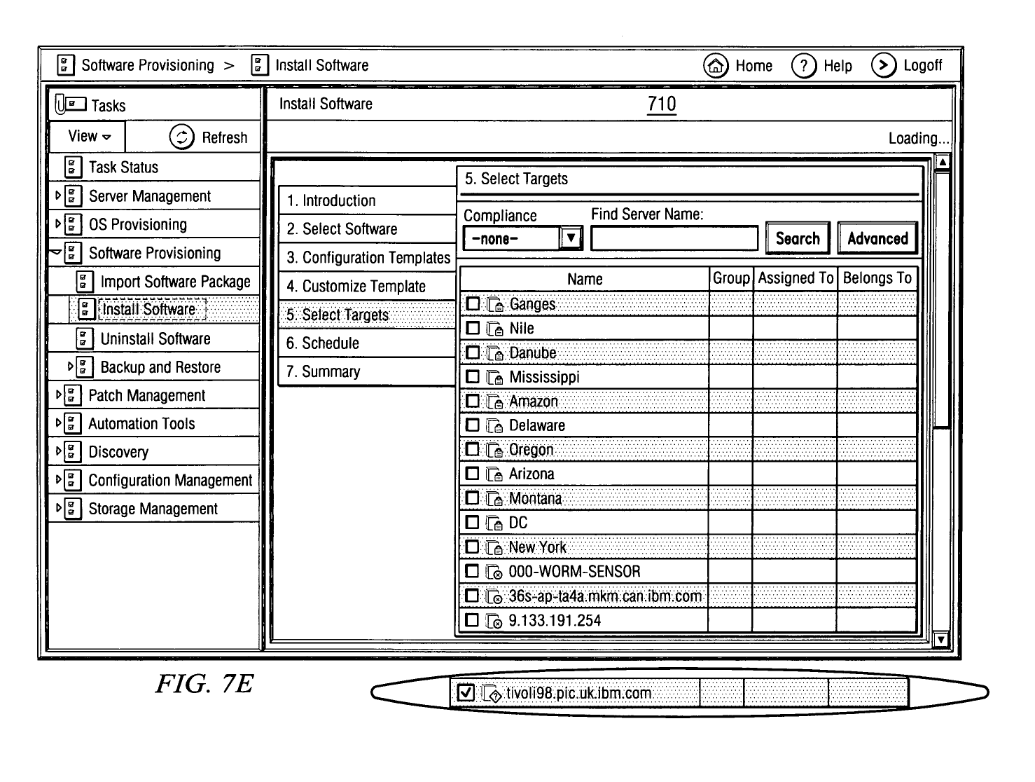

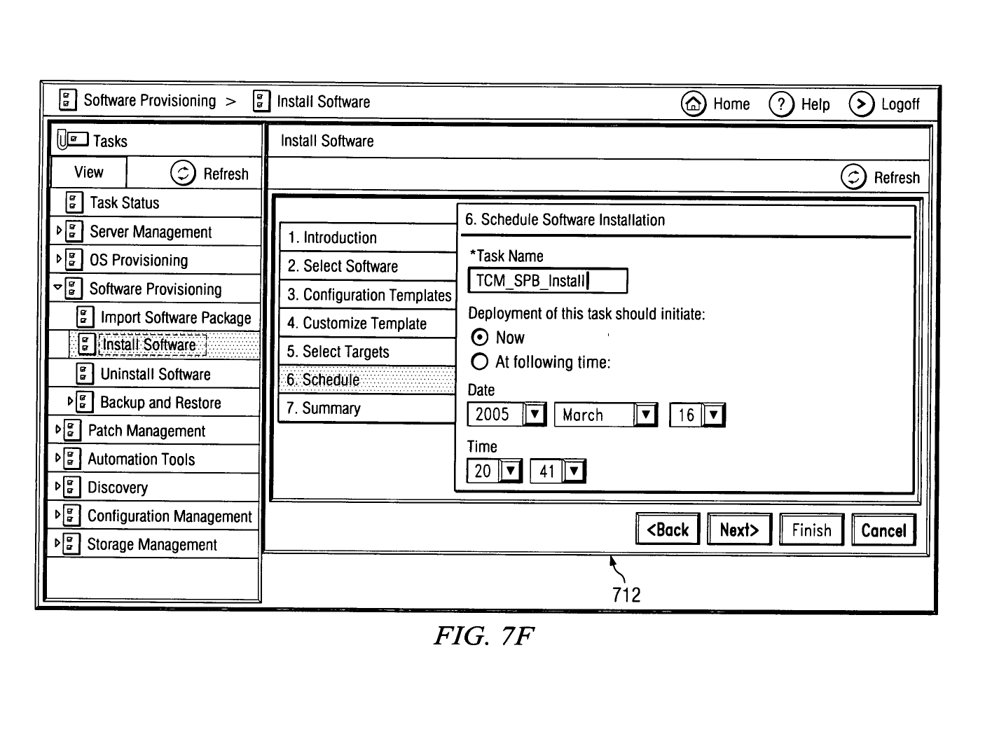

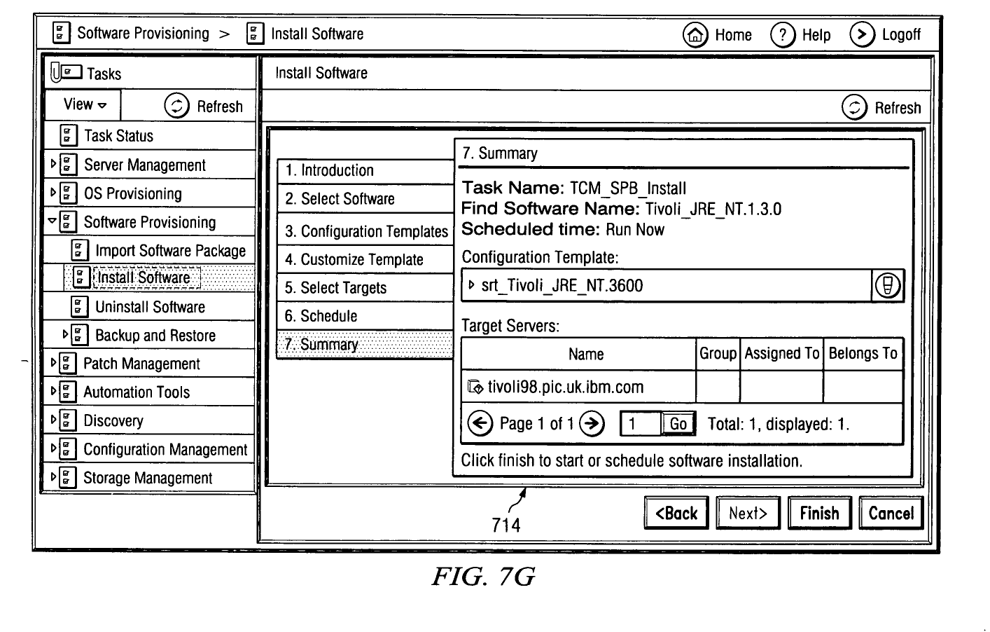

Turning now to FIGS. 7A-7G, diagrams illustrating deployment of software is depicted in accordance with an illustrative embodiment of the present invention. In FIG. 7A, user interface 700 shows the launching of an install software task. User interface 702 in FIG. 7B illustrates selection of software. In this particular example, the software in section 704 has been selected in user interface 702 for deployment. Next, FIG. 7C shows the selection of a configuration template in user interface 706. In this example, a template is selected by the user for use in deploying the software. This template includes installation parameters for use in installing or deploying the software. User interface 708 in FIG. 7D illustrates a user input to customize installation parameters. In this manner, a user may change installation parameters for deploying software. In FIG. 7E, user interface 710 illustrates selection of a target for deploying the software. In these examples, the software may be deployed to various locations that are serviced by the data center. In FIG. 7F, user interface 712 shows scheduling of the deployment for the software. Next, user interface 714 in FIG. 7G shows a summary of the software deployment that has been scheduled.

The user does not require selecting a particular software deployment application to deploy the software. Instead, the mechanism of the present invention selects an appropriate software deployment application based on the installation parameters input by the user. As a result, the user only needs to be familiar with a single interface and does not need to be familiar with how the different software deployment applications work.

With reference to FIG. 8, a flowchart of a process for discovering software distribution applications is depicted in accordance with an illustrative embodiment of the present invention. The process illustrated in FIG. 8 may be implemented within a data center management application, such as data center management application 500 in FIG. 5. More specifically, the mechanism of the present invention may be implemented in a discovery module, such as discovery module 502 in FIG. 5.

The process begins by discovering software distribution applications (step 800). The discovery of the software distribution application may be implemented in a number of different ways. For example, software distribution applications may be discovered through user input identifying applications that are present in the data center. Alternatively, step 800 may be implemented through processes used to poll or identify components within the data center for software distribution applications. The software distribution applications can be discovered by scanning the network in these illustrative examples. Some software distribution applications like Tivoli Configuration Manager can be identified by detecting certain daemons running on predefined ports of the server. Once the software distribution application is identified the user will have to provide the Administrator credentials of the application and the discovery module can use the APIs of the software distribution application to get its configuration properties. Next, information about the software distribution applications is entered (step 802). In these examples, the information is entered or placed into a database, such as data center database 400. This information may be placed into the database in a number of different ways in these examples. For example, the information on the different characteristics of the software distribution application may be received through user input. Alternatively, the discovery module may locate configuration files for the different software distribution applications. Thereafter, quantifiable and non-quantifiable attributes of the software distribution application are populated (step 804) with the process terminating thereafter.

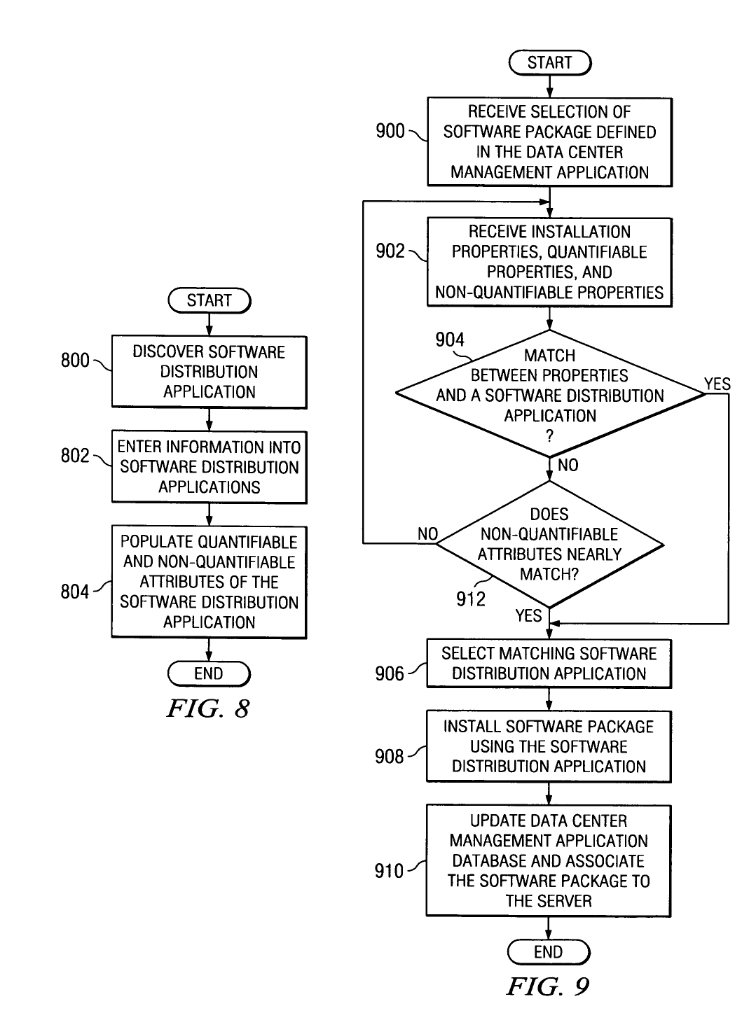

Referring to FIG. 9, a flowchart of a process for deploying software using software distribution applications is depicted in accordance with an illustrative embodiment of the present invention. The process depicted in FIG. 9 may be implemented in a deployment module, such as software deployment module 504 in FIG. 5.

The process begins by receiving a selection of software packages defined in the data center management application (step 900). In these examples, the selection of the software package may be received through a user input, such as those shown in the user interfaces in FIGS. 7A-7G. Next, installation properties, quantifiable properties and non-quantifiable properties are received (step 902). These properties are also referred to as installation parameters in these examples. A determination is made as to whether a match is present between properties and a software distribution application (step 904). If a match is present, the software distribution application in the set of software distribution applications having characteristics matching the installation parameters is selected (step 906). If there is not a match, then another determination is made as to whether non-quantifiable attributes nearly match (step 912). Non quantifiable attributes that are some the user knows by experience. For example the user may have figured out that a particular software distribution application works well if it is installed on a Linux Operating system compared to a Windows operating system. If the non-quantifiable attributes do not nearly match, the step returns to step 902. The process returns to step 902 in these examples to change installation parameters. If the non-quantifiable properties do nearly match, then a matching software distribution application is selected (step 906).

Next, the software package is installed using the software distribution application (step 908). Then, the data center management application database is updated and the software package is associated with the server (step 910) with the process terminating thereafter. Step 910 is an optional step used to provide historical data for use in generating reports and responding to queries. Associating the software package with the server helps the management of the server knowing what is installed on the server for future deployment. Alternatively, in step 912, the mechanism of the present invention may select a default software distribution application for use or may terminate the process, send an error message, and have the user start the process again to deploy the software. In step 912, the determination may include finding a software distribution application in the set of software distribution applications, which most closely matches the installation parameters. As another alternative, the distribution of software may occur for a desktop computer or other environment in which a device may not always be connected to a network data processing system. In this situation, the software distribution application used to distribute the software may be selected as one that allows for sending only the portions of the software that were not distributed during the last connection without having to begin the distribution of the software from the beginning.

Thereafter, the user may be prompted to determine whether to accept this software distribution application for use in deploying the software. Alternatively, the determination may be made by seeing if the match is close enough to some threshold or selected parameters have been met. The selected parameters may be ones that are selected by the users as ones that must always be matched with the software distribution application, while other parameters may not necessarily need to match the characteristics of the software distribution application.

Thus, the present invention provides an improved method, apparatus, and computer usable code for deploying software within a data center. The mechanism of the present invention in the illustrative examples selects a software distribution application from a set of software distribution applications based on installation parameters received for deploying the software. In this manner, a user does not need to know how to configure and use different software installation applications.

In an illustrative embodiment, the present invention provides a first mechanism that generates and deploys multiple instances of an application using a deployment plan template. For each instance of the application, there are variations in configurations of the application. Examples of application configurations include network configurations, operating systems on which the application runs, and different combinations of software stack that supports the application.

In order to accommodate these variations, a deployment plan template may be used to generate multiple deployment plans based on the different deployment parameters. The deployment plan template is a parameterized deployment plan that has variables corresponding to parameters defined in deployment parameter sets. Some examples of deployment parameters include IP address information, router information, and cluster information.

When binding with different deployment parameter sets, the deployment plan template may be used to generate corresponding deployment plans. With the generated deployment plans, multiple application instances may then be deployed into the data center with the help of a data center automation system.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. For example, the illustrative embodiments show the application of the mechanism of the present invention in a data center. The mechanism of the present invention may be applied to any type of information technology infrastructure. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method in a network data processing system for deploying software the method comprising:
identifying a set of software distribution applications within the network data processing system;
responsive to receiving a request to install the software, comparing installation parameters associated with the software to characteristics for the set of software distribution applications;
selecting a software distribution application from the set of software distribution applications based on comparing the installation parameters associated with the software to the characteristics for the set of software distribution applications to form a selected software distribution application; and
installing the software using the selected software distribution application.

2. The method of claim 1, wherein the identifying step comprises:
scanning the network data processing system for a presence of the set of software distribution applications.

3. The method of claim 1, wherein the identifying step comprises:
receiving a user input identifying the set of software distribution applications within the network data processing system.

4. The method of claim 1, wherein identifying step comprises:
storing an identification of each software distribution application within the set of software distribution applications in association with characteristics of the each software distribution application.

5. The method of claim 1, wherein the comparing step comprises:
determining whether a match is present between the installation parameters associated with the software to characteristics of a particular software distribution application in the set of software distribution applications.

6. The method of claim 5, wherein the selecting step comprises:
selecting the particular software distribution application when the match is present; and
selecting another software distribution application from the set of software distribution application in response to an absence of the match.

7. The method of claim 6, wherein the step of selecting another software distribution application from the set of software distribution application in response to an absence of the match comprises:
selecting the another software distribution application from the set of software distribution applications as one that most closely matches the installation parameters.

8. The method of claim 5, wherein the installation parameters includes at least one of an amount of bandwidth used to distribute the software, whether asynchronous deployments is required, and a type of device to which the software is to be deployed.

9. The method of claim 1, wherein the network data processing system is a data center.

10. The method of claim 1, wherein the software is deployed within a data center and desktop computers.

11. A computer program product for deploying computer usable code, the computer program product comprising:
a computer usable medium having computer usable program code for deploying software in a data center, said computer program product including:
computer usable program code for identifying a set of software distribution applications within the network data processing system;
computer usable program code for comparing installation parameters associated with the software to characteristics for the set of software distribution applications in response to receiving a request to install the software;
computer usable program code for selecting a software distribution application from the set of software distribution applications based on comparing the installation parameters associated with the software to the characteristics for the set of software distribution applications to form a selected software distribution application; and
computer usable program code for installing the software using the selected software distribution application.

12. The computer program product of claim 11, wherein the computer usable program code for identifying a set of software distribution applications within the data center further comprises:
computer usable program code for scanning the network data processing system for a presence of the set of software distribution applications.

13. The computer program product of claim 11, wherein the computer usable program code for identifying a set of software distribution applications within the network data processing system further comprises:
computer usable program code for receiving a user input identifying the set of set of software distribution applications within the data center.

14. The computer program product of claim 11, wherein the computer usable program code for identifying a set of software distribution applications within the data center comprises:
computer usable program code for storing an identification of each software distribution application within the set of software distribution applications in association with characteristics of the each software distribution application.

15. The computer program product of claim 11, wherein the computer usable program code for comparing installation parameters associated with the software to characteristics for the set of software distribution applications in response to receiving a request to install the software comprises:
computer usable program code for determining whether a match is present between the installation parameters associated with the software to characteristics of a particular software distribution application in the set of software distribution applications.

16. The computer program product of claim 15, wherein the computer usable program code for selecting a software distribution application from the set of software distribution application based on comparing the installation parameters associated with the software to the characteristics for the set of software distribution applications to form a selected software distribution application comprises:
computer usable program code for selecting the particular software distribution application when the match is present; and
computer usable program code for selecting another software distribution application from the set of software distribution application in response to an absence of the match.

17. The computer program product of claim 16, wherein the computer usable program code for selecting another software distribution application from the set of software distribution application in response to an absence of the match comprises:
computer usable program code for selecting the another software distribution application from the set of software distribution applications as one that most closely matches the installation parameters.

18. The computer program product of claim 15, wherein the installation parameters includes at least one of an amount of bandwidth used to distribute the software, whether asynchronous deployments is required, and a type of device to which the software is to be deployed.

19. A data processing system comprising:
a bus;
a communications unit connected to the bus;
a memory connected to the bus, wherein the memory includes a computer usable code; and
a processor unit connected to the bus, wherein the processor unit executes the computer usable code to identify a set of software distribution applications within a network data processing system; compare installation parameters associated with the software to characteristics for the set of software distribution applications in response to receiving a request to install the software; select a software distribution application from the set of software distribution applications based on comparing the installation parameters associated with the software to the characteristics for the set of software distribution applications to form a selected software distribution application; and install the software using the selected software distribution application.

20. A method for deploying software in a network data processing system, the method comprising:
transmitting computer useable code to the network data processing system in which the computer useable code in combination with the network data processing system, is capable of performing the steps of:
identifying a set of software distribution applications within the network data processing system;
comparing installation parameters associated with the software to characteristics for the set of software distribution applications in response to receiving a request to install the software;
selecting a software distribution application from the set of software distribution applications based on comparing the installation parameters associated with the software to the characteristics for the set of software distribution applications to form a selected software distribution application; and
installing the software using the selected software distribution application.
